(19) United States
(12) Patent Application Publication
(10) Pub. No.: US 2019/0162257 A1
(43) Pub. Date: May 30, 2019

(54) Unidirectional Rotary Brake

(71) Applicant: TAI-WORLD MFG.CO., LTD, Changhua City (TW)

(72) Inventor: Sen-Tien Shih, Changhua City (TW)

(21) Appl. No.: 15/821,938

(22) Filed: Nov. 24, 2017

(51) Int. Cl. F16D 63/00; F16D 65/02

(52) U.S. Cl. CPC F16D 63/00; F16D 2121/18; F16D 65/028

(57) ABSTRACT

A unidirectional rotary brake contains: a body, multiple rollers, two driving rings, and at least one returning means. The body includes an internal face and two end faces, wherein the internal face has multiple accommodation grooves, each accommodation groove has a locking segment and a unlocking segment, and each end face has a surrounding groove. Each of the multiple rollers is columnar and has a diameter which is more than the first depth of the locking segment of each accommodation groove of the body and is less than a second depth of the unlocking segment of each accommodation groove of the body, and each roller has two limiting posts. Each of the multiple orifices is more than each of the two limiting posts and is less than the diameter of each roller. A number of the at least one returning means is less than that of the multiple rollers.

### BACKGROUND OF THE INVENTION

### Field of the Invention

The present invention relates to a rotary brake, and more particularly to a unidirectional rotary brake which provides transmission torque in a unidirectional direction by using power machinery so as to reduce frictional resistance as the unidirectional rotary brake rotates.

### Description of the Prior Art

Conventional unidirectional rotary brakes contain a ratchet brake 60, an elastic friction brake 70, and a magnetic friction brake 80.

Referring to FIG. 1, the ratchet brake 60 contains a central shaft 61 on which multiple springs 62 are arranged, multiple ratchet teeth 63 correspond to the multiple springs 62 respectively and pushed to multiple ratchets 64 individually so that when the central shaft 61 rotates in one direction, the multiple ratchet teeth 63 retain with and drive the multiple ratchets 64 respectively; and when the central shaft 61 rotates in another direction, the multiple ratchet teeth 63 press the multiple springs 62 to move on the multiple ratchets 64 individually and to rotate idly. When the ratchet brake 60 rotates idly, the multiple ratchet teeth 63 are pushed by the multiple springs 62 to move to the multiple ratchets 64, thus producing moving resistance.

As shown in FIG. 2, the elastic friction brake 70 contains a bearing ring 71 on which multiple springs 72 are arranged and push multiple friction elements 73 to a central shaft 74, hence when the elastic friction brake 70 rotates in one direction, the multiple friction elements 73 movably press the multiple springs 72 and rotate idly by mating with the central shaft 74; when the elastic friction brake 70 rotates in another direction, the multiple friction elements 73 rotate reversely and are pushed outwardly by the multiple springs 72, and the multiple friction elements 73 retain with the bearing ring 71 and the central shaft 74. The elastic friction brake 70 idly rotates between the multiple friction elements 73 and the central shaft 74, and the multiple friction elements 73 are pushed by the multiple springs 72 to be against the central shaft 74 and the bearing ring 71.

When the multiple springs 62, 72 move and jump, an idle resistance of the unidirectional rotary brake increases, for example, when the unidirectional rotary brake is secured on the bicycle, the idle resistance greatly reduces a slide distance as not stepping the bicycle, thus decreasing jumping or rolling resistance and saving riding force.

As illustrated in FIGS. 3-5, the magnetic friction brake 80 contains a bearing ring 81 on which multiple locking slots 82 are defined, each of the multiple locking slots 82 has a magnet 83 accommodated on a bottom thereof, and a friction element 84 is fixed in each locking slot 82 and is magnetically attracted by the magnet 83, wherein each magnet 83 magnetically attracts the friction element 84 to move to a central shaft 85. When the bearing ring 81 rotates in one direction, the friction element 84 slides on each magnet 83 and rotates idly by mating with the central shaft 85. When the bearing ring 81 rotates in another direction, the friction element 84 is magnetically attracted by each magnet 83 to move back to an original position, and the friction element 84 retains with and drives the bearing ring 81 and the central shaft 85 to rotate. As rotating idly, the friction element 84 produces a resistance to the central shaft 85, and the resistance is a magnetic attraction resistance when each magnet 83 magnetically attracts the friction element 84.

The central shaft 61 of the ratchet brake 60 actuates each ratchet tooth 63 of each ratchet 64 by using each spring 62. The central shaft 74 of the elastic friction brake 70 drives each friction element 73 of the bearing ring 71 by using each spring 72. The central shaft 85 of the magnetic friction brake 80 drives each friction element 84 of the bearing ring 81 by using each magnet 82. When each spring 62, 72 and each magnet 83 rotates idly, a resistance forms to the central shaft 61, 74, 85, hence the slide distance reduces as not stepping the bicycle. Therefore, when numbers of the multiple springs 62, 72 or the multiple magnets 83 reduces, the resistance decreases, wherein the numbers of the multiple springs 62, 72 or the multiple magnets 83 correspond to those of the multiple ratchet teeth 63 or the multiple friction elements 73, 84, and numbers of the multiple ratchet teeth 63 or the multiple friction elements 84 are related to torque, i.e., the more numbers are, the stronger torque is, but the torque is lowered in order to decrease frictional resistance of idle rotation.

The present invention has arisen to mitigate and/or obviate the afore-described disadvantages.

### SUMMARY OF THE INVENTION

The primary objective of the present invention is to provide a unidirectional rotary brake in which at least one returning means drives two driving rings so that the two driving rings actuate multiple rollers to rotate simultaneously, wherein increasing numbers of at least one spring and at least one magnet is not required by increasing the number of the multiple rollers so as to reduce frictional resistance of idle rotation greatly and to increase torque.

To obtain above-mentioned objectives, a unidirectional rotary brake provided by the present invention contains: a body, multiple rollers, two driving rings, and at least one returning means.

The body includes an internal face and two end faces, wherein the internal face has multiple accommodation grooves separately arranged thereon and matching with the multiple rollers respectively, each of the multiple accommodation grooves has a locking segment and a unlocking segment, a first depth of the locking segment is less than a second depth of the unlocking segment, and each of the two end faces has a surrounding groove formed thereon.

The multiple rollers are accommodated in the multiple accommodation grooves of the body respectively, and each of the multiple rollers moves between the locking segment and the unlocking segment of the body, wherein each roller is columnar and has a diameter which is more than the first depth of the locking segment of each accommodation groove of the body and is less than the second depth of the unlocking segment of each accommodation groove of the body, and each roller has two limiting posts extending outwardly from two opposite ends thereof respectively.

The two driving rings are housed in two surrounding grooves of the two end faces of the body individually, and a rotatable angle produces between the two driving rings, wherein each driving ring has multiple orifices, each of the multiple orifices is more than each of the two limiting posts and is less than the diameter of each roller, and each limiting post is accommodated in each of the multiple orifices so that when each driving ring produces an angular rotation, each roller is driven synchronously.

Preferably, a number of the at least one returning means is less than that of the multiple rollers so as to push the two driving rings to the locking segment from the unlocking segment.

### BRIEF DESCRIPTION OF THE DRAWINGS

FIG. 1 is a cross sectional view of a conventional ratchet brake.

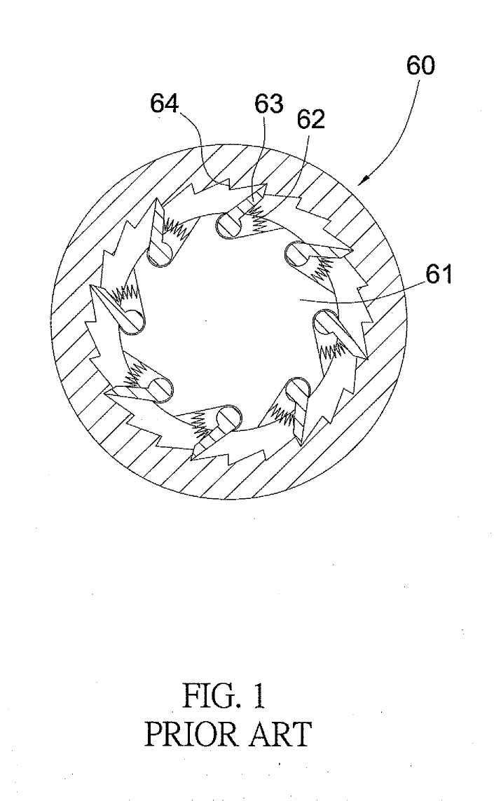

FIG. 2 is a cross sectional view of a conventional elastic friction brake.

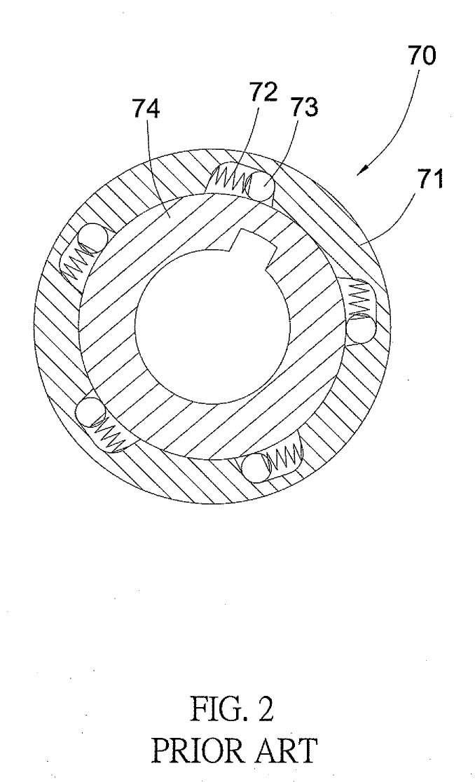

FIG. 3 is a perspective view of a conventional magnetic friction brake.

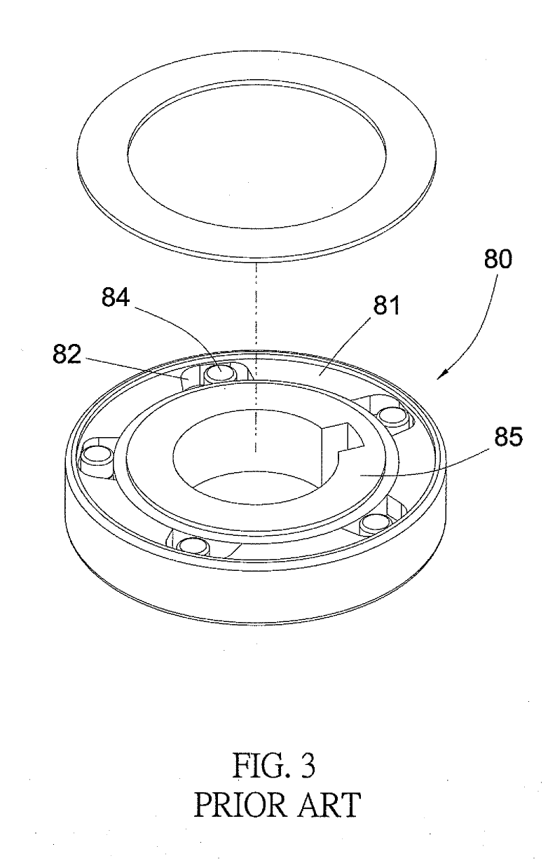

FIG. 4 is a cross sectional view of the conventional magnetic friction brake.

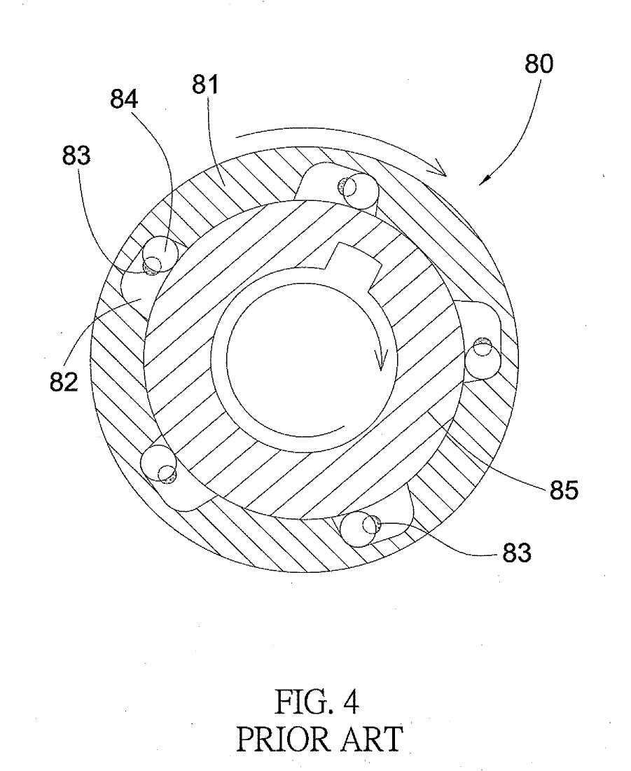

FIG. 5 is another cross sectional view of the conventional magnetic friction brake.

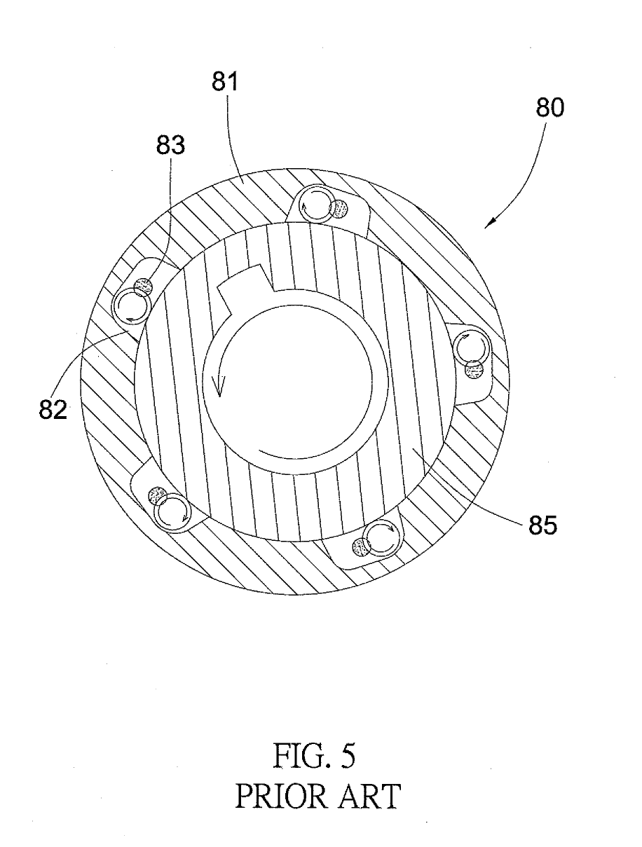

FIG. 6 is a perspective view showing the assembly of a unidirectional rotary brake in accordance with a first embodiment of the present invention.

FIG. 7 is a perspective view showing the exploded components of the unidirectional rotary brake in accordance with the first embodiment of the present invention.

FIG. 8 is a perspective view showing the exploded components of a part of the unidirectional rotary brake in accordance with the first embodiment of the present invention.

FIG. 9 is a cross sectional view showing the assembly of the unidirectional rotary brake in accordance with the first embodiment of the present invention.

FIG. 10 is a cross sectional view showing the assembly of a part of the unidirectional rotary brake in accordance with the first embodiment of the present invention.

FIG. 11 is another cross sectional view showing the assembly of the unidirectional rotary brake in accordance with the first embodiment of the present invention.

FIG. 12 is a cross sectional view showing the operation of the unidirectional rotary brake in accordance with the first embodiment of the present invention.

FIG. 13 is another cross sectional view showing the operation of the unidirectional rotary brake in accordance with the first embodiment of the present invention.

FIG. 14 is a cross sectional view showing the operation of the unidirectional rotary brake in accordance with a second embodiment of the present invention.

FIG. 15 is another cross sectional view showing the operation of the unidirectional rotary brake in accordance with the second embodiment of the present invention.

FIG. 16 is a cross sectional view showing the assembly of the unidirectional rotary brake in accordance with a third embodiment of the present invention.

### DETAILED DESCRIPTION OF THE PREFERRED EMBODIMENTS

The present invention will be clearer from the following description when viewed together with the accompanying drawings, which show, for purpose of illustrations only, a preferred embodiment in accordance with the present invention.

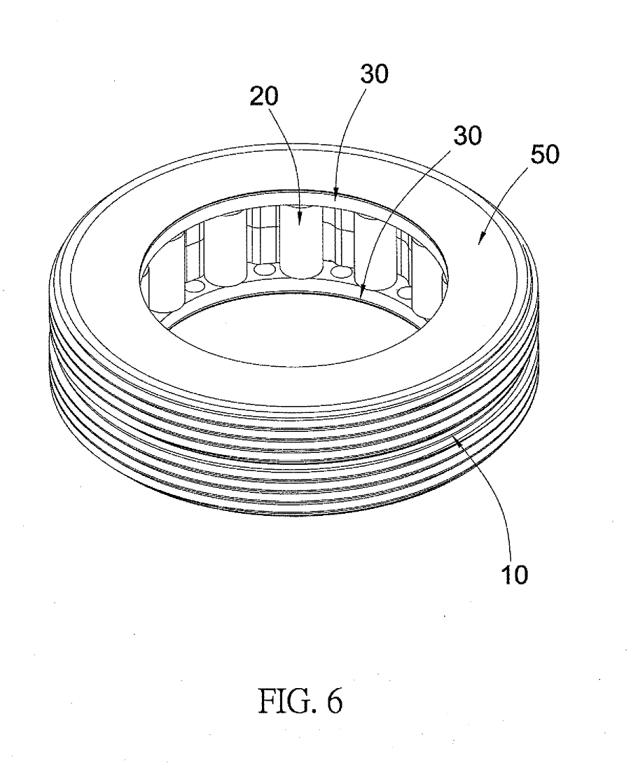

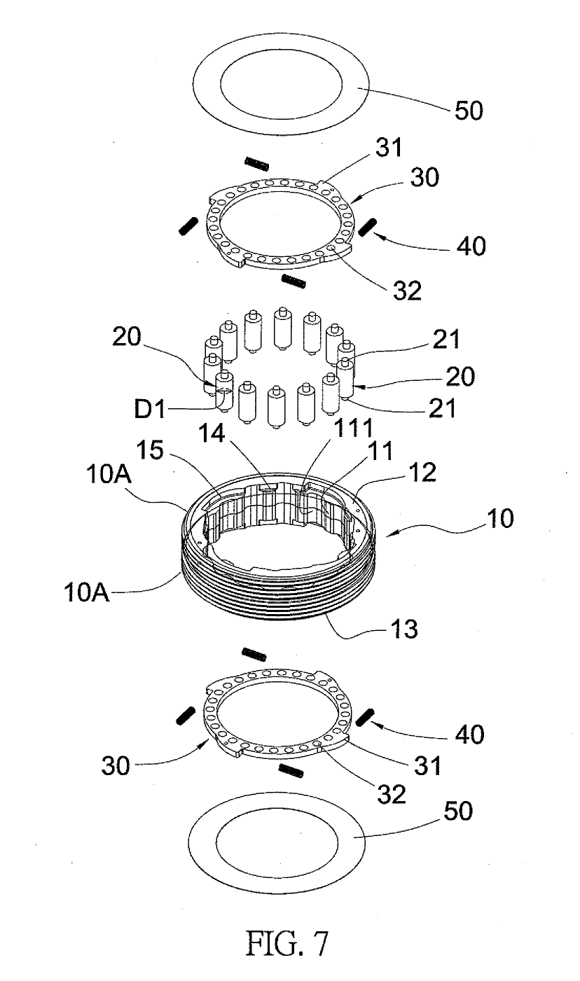

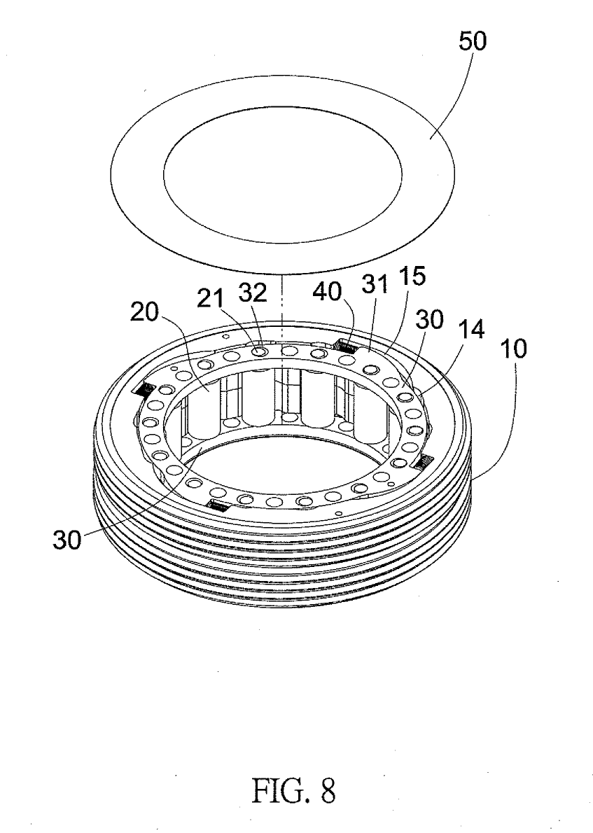

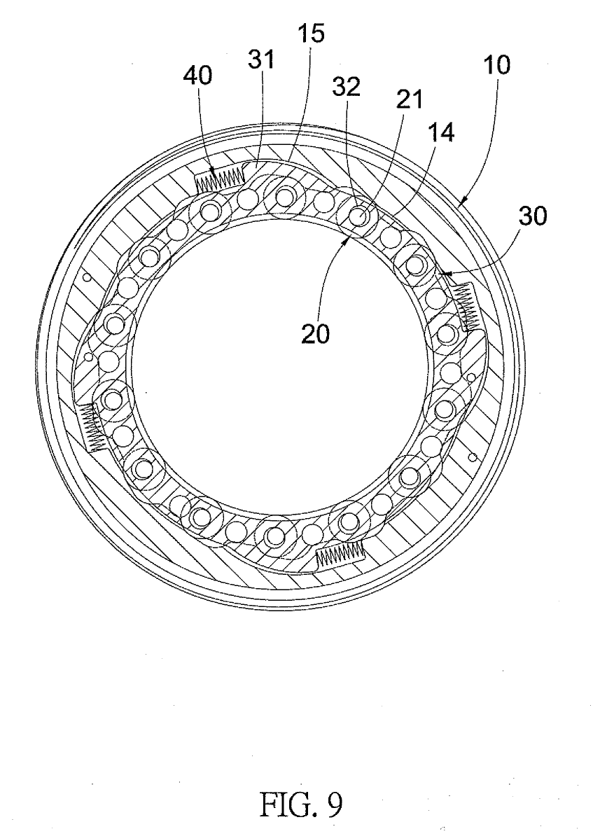

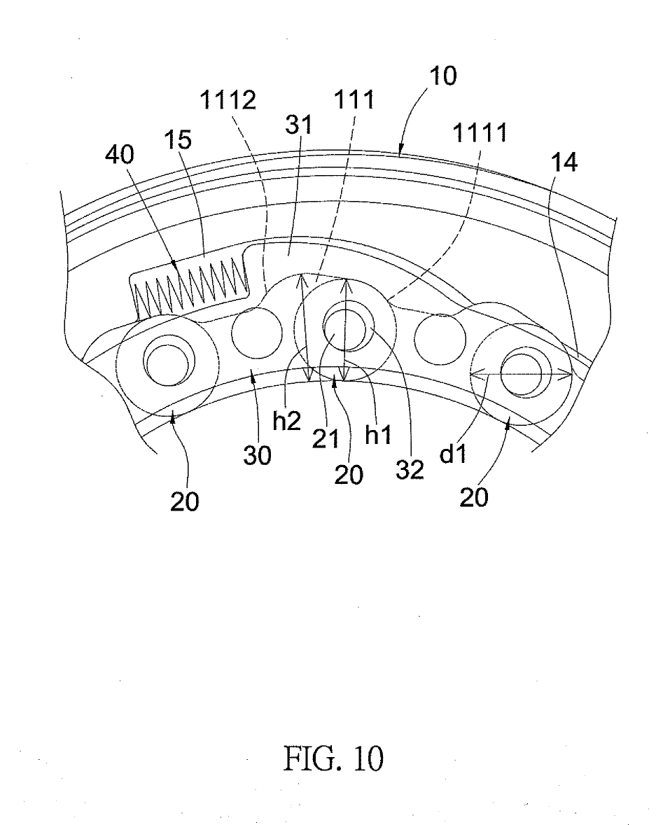

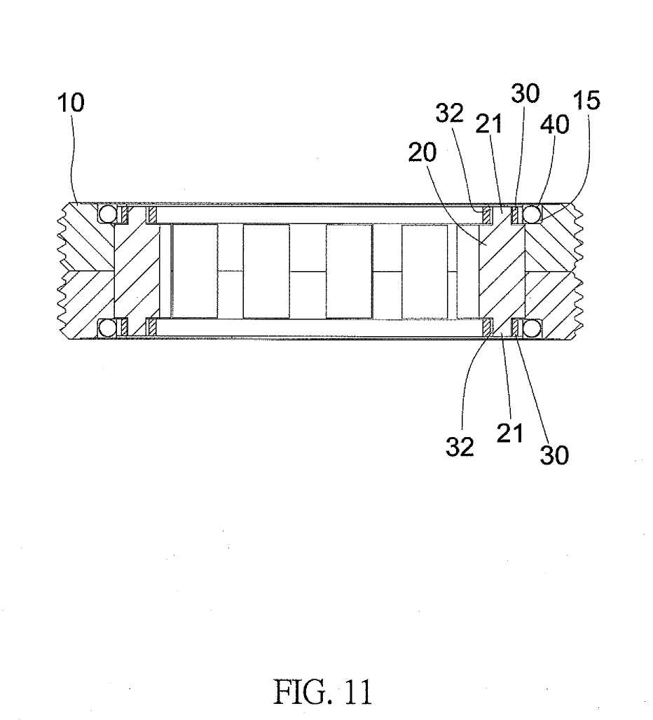

With reference to FIGS. 6-11, a unidirectional rotary brake in accordance with a first embodiment of the present invention comprises: a body 10, multiple rollers 20 (in this embodiment, fourteen rollers 20 are provided), two driving rings 30, at least one returning means 40, and two covers 50.

The body 10 includes at least one annular part 10A, in this embodiment, the body 10 includes two annular parts 10A stacking together, an internal face 11, and two end faces 12, 13, wherein the internal face 11 has multiple accommodation grooves 111 separately arranged thereon and matching with the multiple rollers 20 respectively (in this embodiment, fourteen accommodation grooves 111 are provided), and the multiple accommodation grooves 111 pass through the two end faces 12, 13 of the body 10, wherein each of the multiple accommodation grooves 111 has a locking segment 1111 and a unlocking segment 1112, and a first depth h1 of the locking segment 1111 is less than a second depth h2 of the unlocking segment 1112. Each of the two end faces 12, 13 has a surrounding groove 14 formed thereon and has at least one return trench 15 mating with the surrounding groove 14 (in this embodiment, four return trenches 15 are provided), and a number of the at least one return trench 15 is less than that of the multiple rollers 20.

The multiple rollers 20 are accommodated in the multiple accommodation grooves 111 of the body 10 respectively, and each of the multiple rollers 20 moves between the locking segment 1111 and the unlocking segment 1112 of the body 10, wherein each roller 20 is columnar and has a diameter dl which is more than the first depth h1 of the locking segment 1111 of each accommodation groove 111 of the body 10 and is less than a second depth h2 of the unlocking segment 1112 of each accommodation groove 111 of the body 10, and each roller 20 has two limiting posts 21 extending outwardly from two opposite ends thereof respectively.

The two driving rings 30 are housed in two surrounding grooves 14 of the two end faces 12, 13 of the body 10 individually, and a rotatable angle produces between the two driving rings 30, wherein each of the two driving rings 30 has at least one stop sheet 31 corresponding to the at least one return trench 15, and each driving ring 30 has multiple orifices 32 (in this embodiment, fourteen orifices are provided), wherein each of the multiple orifices 32 is more than each of the two limiting posts 21 and is less than the diameter d 1 of each roller 20, and each limiting post 21 is accommodated in each of the multiple orifices 32 so that when each driving ring 30 produces the angular rotation, each roller 20 is driven synchronously.

The number of the at least one returning means 40 is less than that of the multiple rollers 20, wherein the at least one returning means 40 is a spring or a magnet configured to magnetically attract the multiple rollers 20. In this embodiment, the at least one returning means 40 is the spring which is accommodated in the at least one return trench 15 and abuts against the body 10 and the at least one stop sheet 31 so that the two driving rings 30 are pushed to the locking segment 1111 from the unlocking segment 1112, hence the at least one returning means 40 simultaneously controls the multiple rollers 20 between the locking segment 1111 and the unlocking segment 1112.

The two covers 50 are mounted on the two end faces 12, 13 of the body 10 respectively so as to limit the two driving rings 30, hence the two driving rings 30 produce the angular rotation and do not remove.

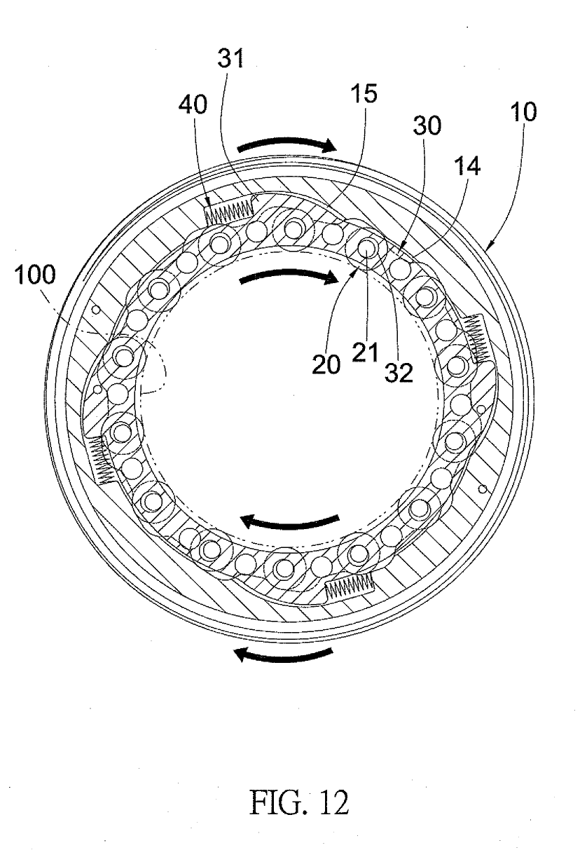

When the multiple rollers 20 drive the body 10, as shown in FIG. 12, a central shaft 100 inserts into a center of the body 10 so as to contact with the multiple rollers 20, wherein when the central shaft 100 rotates clockwise, the two driving rings 30 are pushed by the at least one returning means 40 to rotate clockwise, and the multiple rollers 20 are pushed by the at least one returning means 40 synchronously so that the multiple rollers 20 move to the locking segment 1111 from the unlocking segment 1112, and the multiple rollers 20 are retained with the central shaft 100 and the body 10, thus obtaining actuation.

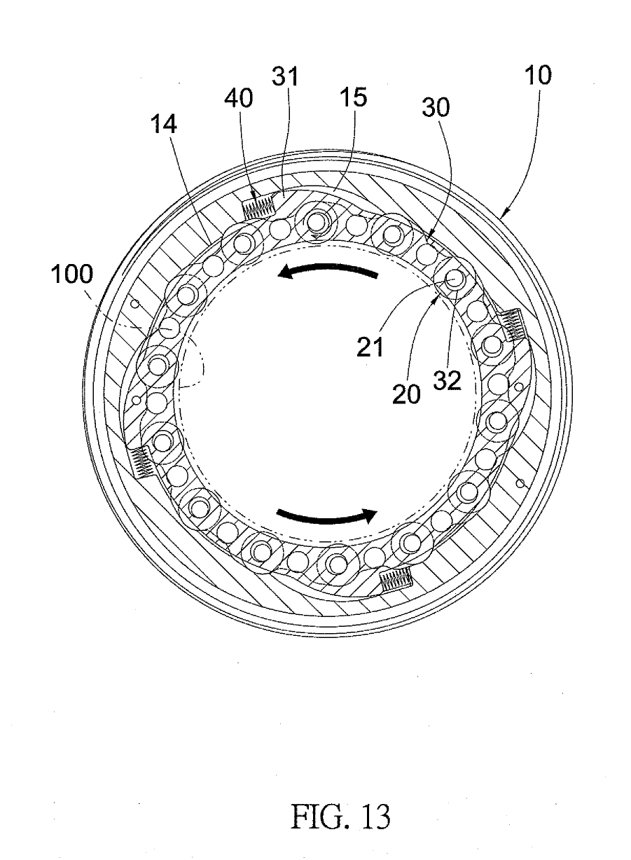

When the body 10 rotates idly, as shown in FIG. 13, the central shaft 100 inserts into the center of the body 10 so as to contact with the multiple rollers 20, the central shaft 100 pushes the multiple rollers 20 counterclockwise, and the multiple rollers 20 reversely push the two driving rings 30 to revolve counterclockwise, hence the multiple rollers 20 move to the unlocking segment 1112 from the locking segment 1111 and remove from the unlocking segment 1112, hence the multiple rollers 20 rotate idly so that the body 10 is not driven and rotates idly.

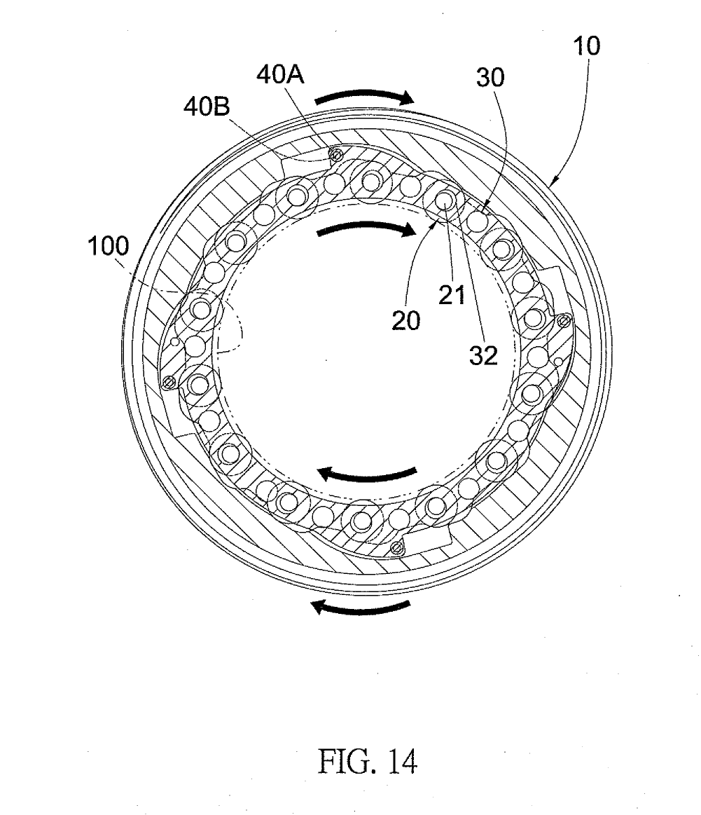

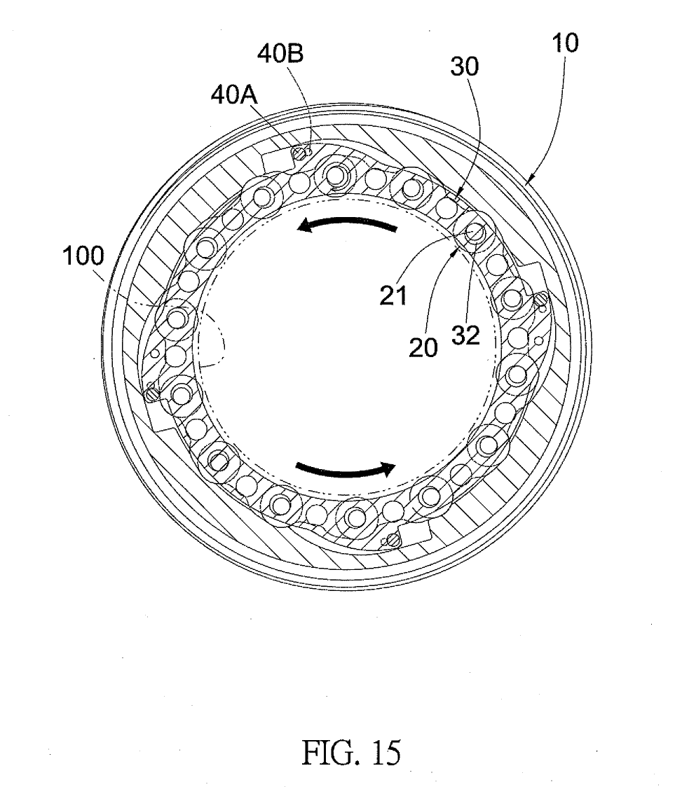

In a second embodiment, as illustrated in FIGS. 14 and 15, the at least one returning means 40 is a magnet 40A and a magnetic attracted member 40B, wherein the magnet 40A is fixed on each of the two driving rings 30, and the magnetic attracted member 40B is secured in the body 10 and corresponds to the magnet 40A, hence the magnet 40A magnetically attracts the magnetic attracted member 40B so as to realize the at least one returning means 40.

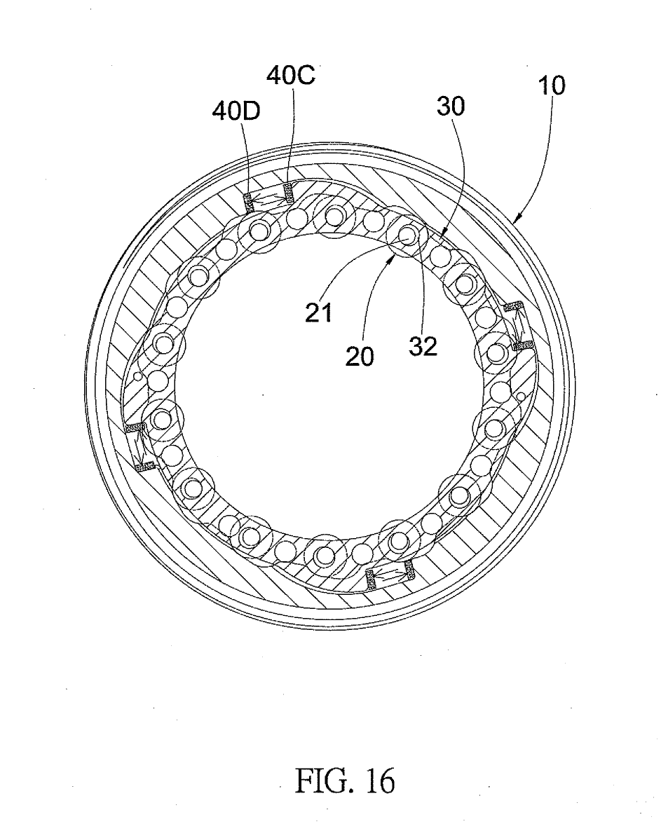

In a third embodiment, as shown in FIG. 16, the at least one returning means 40 is a first magnet 40C and a second magnet 40D, wherein the first magnet 40C is fixed on each of the two driving rings 30, and the second magnet 40D is secured in the body 10 and repels against the first magnet 40C so as to realize the at least one returning means 40.

Accordingly, the unidirectional rotary brake of the present invention has following advantages:

1. The at least one returning means 40 drives the two driving rings 30 so that the two driving rings 30 actuate the multiple rollers 20 to rotate simultaneously, wherein increasing numbers of the at least one spring and the at least one magnet is not required by increasing the number of the multiple rollers 20 so as to reduce frictional resistance of idle rotation greatly and to increase torque. Conventionally, the fourteen rollers match with fourteen springs or fourteen magnets, hence fourteen resistance produce. However, the two driving rings are controlled by four springs so as to simultaneously drive the fourteen rollers, such that the number of the multiple rollers is decreased so as to reduce frictional resistance and to increase driving torque.

2. The two driving rings 30 limit the multiple rollers 20 in the multiple accommodation grooves 111 of the body 10 respectively so as to avoid a removal of the central shaft 100.

While various embodiments in accordance with the present invention have been shown and described, it is clear to those skilled in the art that further embodiments may be made without departing from the scope of the present invention.

What is claimed is:

1. A unidirectional rotary brake comprising: a body, multiple rollers, two driving rings, and at least one returning means;
the body including an internal face and two end faces, wherein the internal face has multiple accommodation grooves separately arranged thereon and matching with the multiple rollers respectively, each of the multiple accommodation grooves has a locking segment and a unlocking segment, a first depth of the locking segment is less than a second depth of the unlocking segment, and each of the two end faces has a surrounding groove formed thereon;
wherein the multiple rollers are accommodated in the multiple accommodation grooves of the body respectively, and each of the multiple rollers moves between the locking segment and the unlocking segment of the body, wherein each roller is columnar and has a diameter which is more than the first depth of the locking segment of each accommodation groove of the body and is less than the second depth of the unlocking segment of each accommodation groove of the body, and each roller has two limiting posts extending outwardly from two opposite ends thereof respectively;
wherein the two driving rings are housed in two surrounding grooves of the two end faces of the body individually, and a rotatable angle produces between the two driving rings, wherein each driving ring has multiple orifices, each of the multiple orifices is more than each of the two limiting posts and is less than the diameter of each roller, and each limiting post is accommodated in each of the multiple orifices so that when each driving ring produces an angular rotation, each roller is driven synchronously; and
wherein a number of the at least one returning means is less than that of the multiple rollers so as to push the two driving rings to the locking segment from the unlocking segment.

2. The unidirectional rotary brake as claimed in claim 1, wherein the body includes at least one annular part.

3. The unidirectional rotary brake as claimed in claim 1, wherein each of the two end faces of the body has at least one return trench mating with the surrounding groove, and a number of the at least one return trench is less than that of the multiple rollers, each of the two driving rings has at least one stop sheet corresponding to the at least one return trench; and the at least one returning means is a spring which is accommodated in the at least one return trench and abuts against the at least one stop sheet.

4. The unidirectional rotary brake as claimed in claim 1, wherein the at least one returning means is a magnet and a magnetic attracted member, the magnet is fixed on each of the two driving rings, and the magnetic attracted member is secured in the body and corresponds to the magnet.

5. The unidirectional rotary brake as claimed in claim 1, wherein the at least one returning means is a first magnet and a second magnet, the first magnet is fixed on each of the two driving rings, and the second magnet is secured in the body and repels against the first magnet.

6. The unidirectional rotary brake as claimed in claim 1 further comprising two covers mounted on the two end faces of the body respectively so as to limit the two driving rings, hence the two driving rings produce the angular rotation and do not remove.

7. A unidirectional rotary brake comprising: a body, multiple rollers, two driving rings, and at least one returning means;
the body including an internal face and two end faces, wherein the internal face has multiple accommodation grooves separately arranged thereon and matching with the multiple rollers respectively, each of the multiple accommodation grooves has a locking segment and a unlocking segment, a first depth of the locking segment is less than a second depth of the unlocking segment;
wherein the multiple rollers are accommodated in the multiple accommodation grooves of the body respectively, each of the multiple rollers is columnar and has a diameter which is more than the first depth of the locking segment of each accommodation groove of the body and is less than the second depth of the unlocking segment of each accommodation groove of the body, and each roller has two limiting posts extending outwardly from two opposite ends thereof respectively;
wherein the two driving rings are fixed on the two end faces of the body individually, and a rotatable angle produces between the two driving rings, wherein each of the two driving rings has multiple orifices, and each of the two limiting posts is accommodated in each of the multiple orifices so that when each driving ring produces an angular rotation, each roller is driven synchronously so as to move between the locking segment and the unlocking segment; and
wherein a number of the at least one returning means is less than that of the multiple rollers so as to push the two driving rings to the locking segment from the unlocking segment.

8. The unidirectional rotary brake as claimed in claim 7, wherein each of the two end faces of the body has a surrounding groove formed thereon, and each driving ring is housed in the surrounding groove of each of the two end faces of the body individually.

9. The unidirectional rotary brake as claimed in claim 7, wherein each of the multiple orifices is more than each of the two limiting posts and is less than the diameter of each roller.
